(19) United States
(12) Patent Application Publication
(10) Pub. No.: US 2025/0180716 A1
(43) Pub. Date: Jun. 5, 2025

(54) IMAGING SYSTEM WITH INCREASED SIGNAL-TO-NOISE RATIO

(71) Applicant: SiLC Technologies, Inc., Monrovia, CA (US)

(72) Inventor: Behnam Behroozpour, South San Francisco, CA (US)

(21) Appl. No.: 18/527,174

(22) Filed: Dec. 1, 2023

(51) Int. Cl. G01S 7/4912; G01S 17/00

(52) U.S. Cl. CPC G01S 7/4917; G01S 17/003

(57) ABSTRACT

A LIDAR system outputs a system output signal and receives a system return signal that includes light from the system output signal that was reflected by an object located outside of the LIDAR system. The LIDAR system includes multiple composite signal generators that receive comparative signals. Each of the composite signal generators receives a different one of the comparative signals and each of the comparative signals includes light from the system return signal. Each of the composite signal generators also receive multiple reference signals such that each of the composite signal generators receives a different one of the reference signals. Different composite signal generators receive reference signals having different power levels. The composite signal generators combine the reference signal received by the composite signal generator with the reference signal received by the composite signal generator so as to generate a composite signal.

### FIELD

The invention relates to optical devices. In particular, the invention relates to LIDAR systems.

### BACKGROUND

LIDAR systems output a system output signal. Objects in the path of the system output signal reflect the system output signal. A portion of the reflected light returns to the LIDAR system as a system return signal. The LIDAR system processes the system return signal to generate LIDAR data that indicates a radial velocity and/or distance between the objects and the LIDAR system.

LIDAR systems can be classified as coaxial (sometimes called monostatic) or biaxial (sometimes called bistatic). In a coaxial LIDAR system, the path that the light travels after being output from the LIDAR system is also traveled by the reflected light returning to the LIDAR system. However, in biaxial systems, the path that the light travels after being output from the LIDAR system is different from the path traveled by the reflected light returning to the LIDAR system.

There are a variety of circumstances where biaxial systems are preferable to coaxial systems. For instance, biaxial systems can often have reduced levels of loss in returned light signals. However, a variety of factors can change where the returned light signals are incident on the LIDAR system. For instance, changes in the distance between the LIDAR system and the reflecting object can change the location where the returned light signals are incident on the LIDAR system. These changes in the location of the returned light signals on the LIDAR system can reduce the signal-to-noise ratio of the signals that are processed by electronics in the LIDAR system. As a result, there is a need for an improved LIDAR system.

### SUMMARY

A LIDAR system outputs a system output signal and receives a system return signal that includes light from the system output signal that was reflected by an object located outside of the LIDAR system. The LIDAR system includes multiple composite signal generators that receive comparative signals. Each of the composite signal generators receives a different one of the comparative signals and each of the comparative signals includes light from the system return signal. Each of the composite signal generators also receive multiple reference signals such that each of the composite signal generators receives a different one of the reference signals. Different composite signal generators receive reference signals having different power levels. The composite signal generators combine the reference signal received by the composite signal generator with the reference signal received by the composite signal generator so as to generate a composite signal.

A method of operating a system includes transmitting a system output signal from a LIDAR system. The method also includes receiving at the LIDAR system a system return signal that includes light from the system output signal and that was reflected by an object located outside of the LIDAR system. The method also includes generating composite signals such that an active selection of the composite signals each includes a comparative signal combined with a reference signal. Each of the comparative signals includes light from the system return signal. An inactive selection of the composite signals each includes a reference signal and substantially excludes light from the system return signal. The composite signals included in the active selection and in the inactive selection change as a distance between the LIDAR system and the object changes. The power level of the reference signals in the active selection of composite signals decreases as the distance between the LIDAR system and the object decreases.

### BRIEF DESCRIPTION OF THE FIGURES

FIG. 1A is a topview of a biaxial LIDAR system.

FIG. 1B is a schematic of a composite signal generator that is suitable for use in a LIDAR chip constructed according to FIG. 5A.

FIG. 1C is a schematic of an example of a portion of the electronics that are suitable for use with the LIDAR system of FIG. 1A.

FIG. 1D is a graph illustrating the frequency versus time pattern for a system output signal and/or a LIDAR output signal.

FIG. 2A is a schematic of an example of signal distributor.

FIG. 2B is a schematic of another example of signal distributor.

FIG. 2C is a schematic of another example of signal distributor.

FIG. 3A is a cross section of a waveguide suitable for use as all or a portion of the waveguides on a LIDAR chip.

FIG. 3B is a topview of a portion of the LIDAR chip where multiple channel waveguide(s) terminate at a lateral side of the LIDAR chip.

FIG. 3C is a cross section of the portion of the LIDAR chip shown in FIG. 3B taken along the line labeled F in FIG. 3B.

FIG. 3D is a topview of a portion of the LIDAR chip where a channel waveguide terminates at a lateral side of the LIDAR chip.

FIG. 3E is a cross section of the device taken along the line labeled H in FIG. 3D.

FIG. 4A is a cross section of a portion of a LIDAR system showing an example of an interface between a LIDAR chip, a beam scanner, and a signal shaper.

FIG. 4B is a cross section of a portion of a LIDAR system showing an example of an interface between a LIDAR chip, a beam scanner, and a signal shaper.

FIG. 5 is a cross section of an in-line light sensor that is suitable for use in a LIDAR chip.

### DESCRIPTION

A LIDAR system outputs a system output signal and receives a system return signal that includes light from the system output signal that was reflected by an object located outside of the LIDAR system. The LIDAR system also includes multiple different channel waveguides. A selection of the channel waveguides can receive a LIDAR input signal that includes light from the system output signal. The portion of the LIDAR input signal that enters a channel waveguide serves as a comparative signal guided by the channel waveguide. The channel waveguides are arranged such that the selection of channel waveguides that carry comparative signals changes in response to changes in the distance between the object and the LIDAR system.

The LIDAR system includes multiple different composite signal generators that are each configured to combine a comparative signal with a reference signal so as to generate a composite signal having a beat frequency. In some instances, all or a portion of the different composite signal generators do not receive a comparative signal. As a result, all or a portion of the composite signals may not have a contribution from a comparative signal while still having a contribution from a reference signal. The composite signals, or representations of each composite signal, are added together so as to generate a data signal. Electronics use the beat frequency of the data signal to generate LIDAR data. The LIDAR data indicates the radial velocity and/or the distance between the LIDAR system and the reflecting object.

Since each of the composite signals has a contribution from a reference signal, the reference signals are a source of noise in the data signals that result from adding the composite signals, or the representation of the composite signals. However, different reference signals can have different power levels and the power levels can be selected to increase the signal-to-noise ratio in the data signal. For instance, as a reflecting object becomes further from the LIDAR system, the power of the system return signal and the resulting comparative signal becomes weaker. The weaker comparative signal is combined with a more powerful reference signal to increase the signal-to-noise ratio of the resulting composite signal and accordingly the resulting data signal. Accordingly, the different comparative signals that result from an object moving closer to the LIDAR system are each combined with a different reference signal having decreasing power levels to increase the signal-to-noise ratio of the resulting data signal.

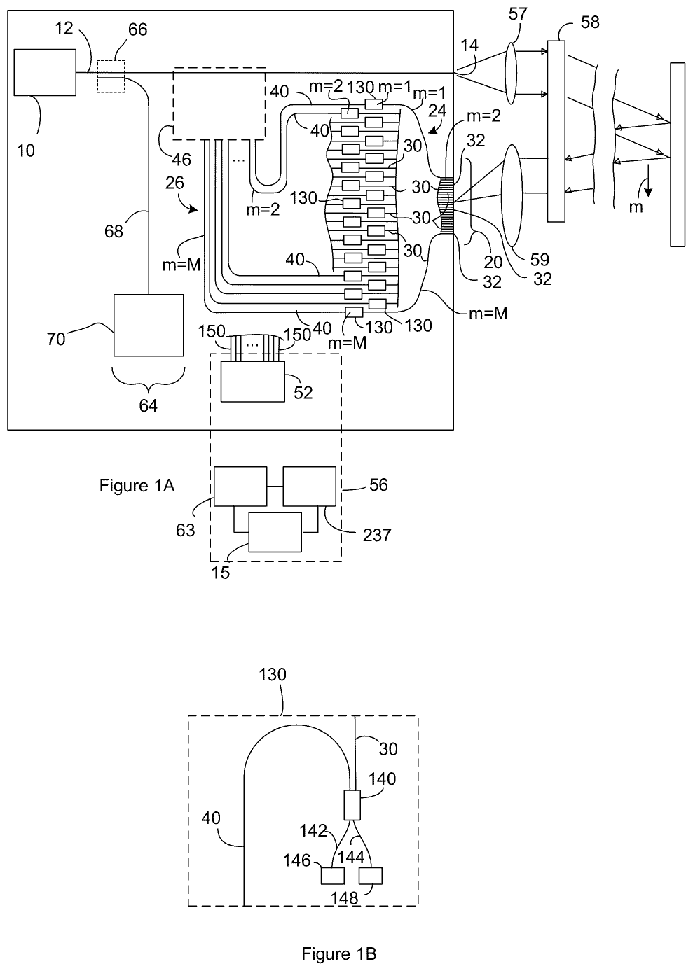

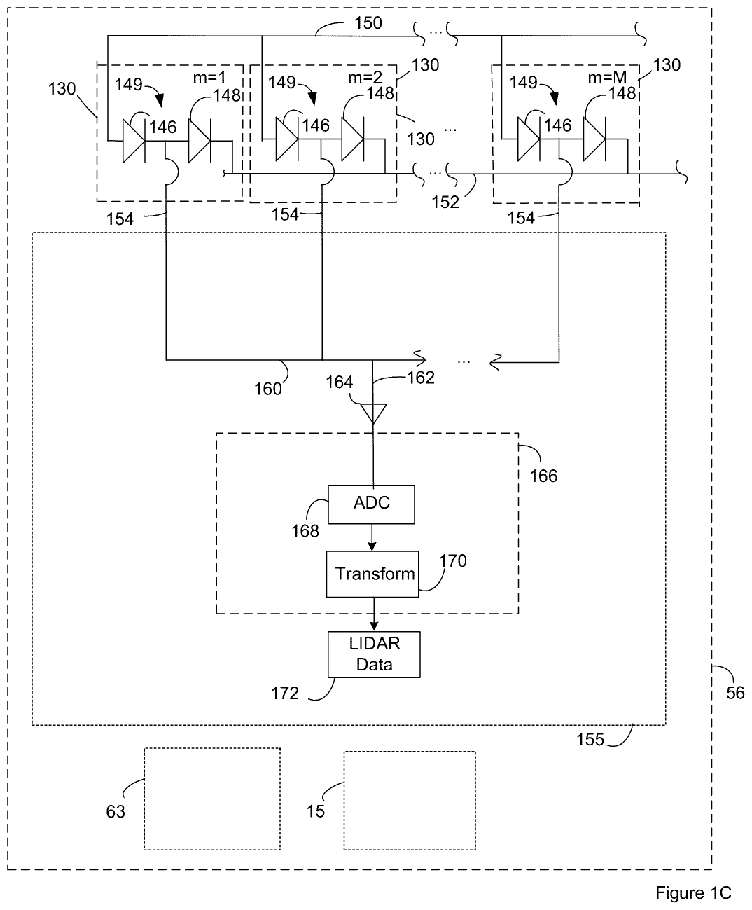

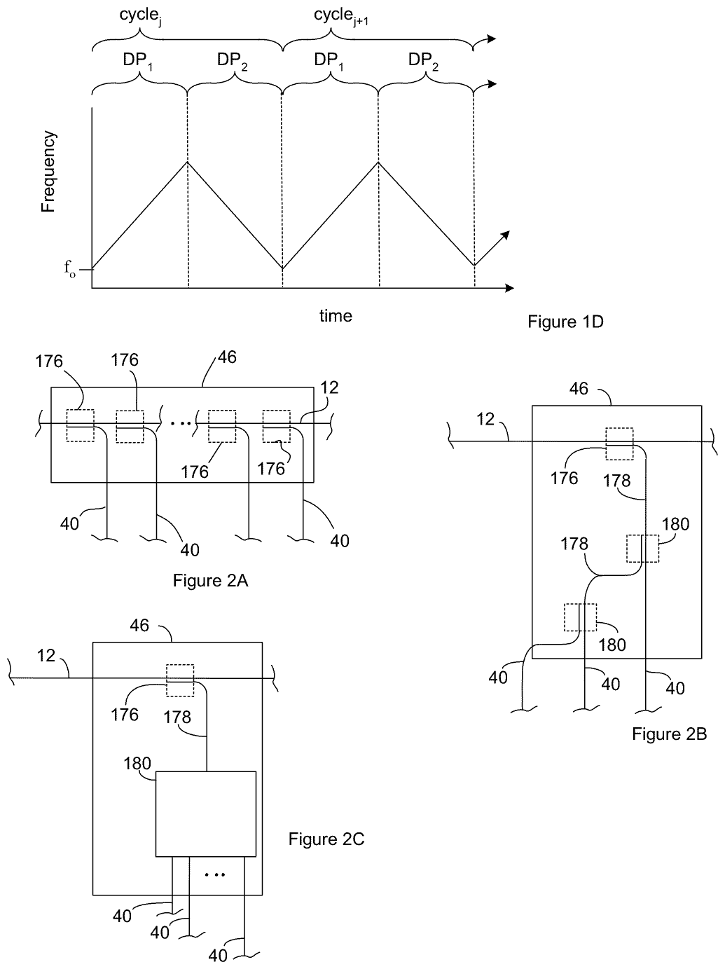

FIG. 1A is a topview of a schematic of a LIDAR system. The LIDAR system includes a LIDAR chip with a light source 10 that outputs an outgoing LIDAR signal. A suitable light source 10 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip also includes a utility waveguide 12 that receives the outgoing LIDAR signal from the light source 10. The utility waveguide 12 terminates at an output component 14 and carries the outgoing LIDAR signal to the output component 14. The output component 14 can be positioned such that the outgoing LIDAR signal traveling through the output component 14 exits the chip and serves as a LIDAR output signal. For instance, the output component 14 can be positioned at an edge of the chip so the outgoing LIDAR signal traveling through the output component 14 exits the chip and serves as a LIDAR output signal. An example of an output component 14 is a facet of the utility waveguide.

Light from the LIDAR output signal travels away from the LIDAR system and may be reflected by objects in the path of the LIDAR output signal. When the LIDAR output signal is reflected, at least a portion of the reflected light travels returns to the LIDAR system in a system return signal. Additionally, at least a portion of the reflected returns to the LIDAR system as a LIDAR input signal that includes light from the system return signal. In some instances, the system return signal can serve as the LIDAR input signal. The LIDAR chip can include a first waveguide array 24 that includes multiple channel waveguides 30. Light from the LIDAR input signal enters one or more of the channel waveguides 30. For instance, the channel waveguides 30 can each terminate at a facet 32 and the LIDAR input signal enters one or more of the channel waveguides 30 through the corresponding facets 32. The portion of the LIDAR input signal that enters a channel waveguide 30 can serve as a comparative signal that includes or consists of light from the LIDAR input signal. Each of the channel waveguides 30 is configured to carry the comparative signal received by that channel waveguide 30 to a composite signal generator 130. The channel waveguides 30 and the associated composite signal generators 130 can be associated with a channel index with a value of m=1 to M where M represents the number of composite signal generators 130 and/or the number of channel waveguides 30.

The LIDAR chip includes a signal distributor 46 that removes a portion of the outgoing LIDAR signal from the utility waveguide 12 and distributes it among multiple reference waveguides 40 included in a second waveguide array 26. The portion of the outgoing LIDAR signal received by a reference waveguide 40 serves as a reference signal. At least a portion of the reference waveguides 40 each carries one of the reference signals to one of the composite signal generators 130. In some instances, each of the reference waveguides 40 carries one of the reference signals to a different one of the composite signal generators 130. Accordingly, the reference waveguides 40 and reference signals can each be associated with a different one of the channel indices. For instance, each of the reference waveguides 40 and reference signals can be associated with the same channel index as the composite signal generators 130 that receives the reference signal.

The LIDAR system can optionally include components in addition to the LIDAR chip. For instance, the LIDAR system can include one or more signal shapers that shape the signals output from the LIDAR system and/or one or more beam scanners that can be used to steer a system output signal from to different sample regions in the field of view. For instance, the LIDAR system of FIG. 1A includes a first signal shaper 57 that receives the LIDAR output signal and outputs a shaped output signal. A beam scanner 58 receives the shaped output signal and outputs the system output signal. The beam scanner can steer the system output signal to the desired sample region in the field of view. When the system output signal is reflected by an object, the reflected light can serve as a system return signal. The beam scanner 58 can receive the system return signal as shown in FIG. 1A or the beam scanner 58 can be constructed such that the system return signal bypasses the beam scanner 58. The LIDAR system also includes a second signal shaper 59 that receives the system return signal and outputs the LIDAR input signal that is received by the LIDAR chip.

In FIG. 1A, the first signal shaper 57 is a lens configured to collimate the shaped output signal and the second signal shaper 59 is a lens configured to focus the LIDAR input signal. In some instances, the second signal shaper 59 is configured to focus the LIDAR input signal at or near a facet 32 of one or more of the channel waveguides 30. The first signal shaper 57 and the second signal shaper 59 can be combined in a single component. For instance, a single lens can serve as the first signal shaper 57 and the second signal shaper 59.

When the first signal shaper 57 and the second signal shaper 59 are each a lens, the lens serving as the second signal shaper 59 can have a wider aperture than the lens serving as the first signal shaper 57. The increased aperture of the lens serving as the second signal shaper 59 can improve light collection efficiency. In some instances, the improvement in light collection efficiency is desirable to overcome optical loss that results from the offset between the output component 14 and the facets 32 of one or more of the channel waveguides 30. A suitable ratio for the aperture of the lens serving as the second signal shaper 59: the aperture of the lens serving as the first signal shaper 57 includes apertures greater than 1:1, 2:1, or 3:1 and/or less than 5:1, 10:1, or 20:1.

In some instances, components such as signal shapers and beam scanners can be mounted on and/or integrated with the LIDAR chip. In instances, when the LIDAR system excludes components in addition to the LIDAR chip, the signal output from the LIDAR chip can serve as the system output signal. For instance, when a LIDAR system includes a LIDAR chip constructed according to FIG. 1A and excludes components in addition to the LIDAR chip, the LIDAR output signal can serve as the system output signal.

The LIDAR system can include electronics 56. When the LIDAR system includes a beam scanner, the LIDAR system can include a steering controller 15 that is configured to operate the beam scanner so as to steer the system output signals to different sample regions within the field of view of the LIDAR system.

The angle of incidence of the LIDAR input signal on the first waveguide array 24 and/or the location where the LIDAR input signal is incident on the first waveguide array 24 can change in response to the steering of the system output signal and/or in response to changes in the distance between the object and the LIDAR system. For instance, the angle of incidence of the LIDAR input signal on the on the edge of the LIDAR chip that includes the facets 32 of the channel waveguides 30 and/or the location where the LIDAR input signal is incident on the edge of the LIDAR chip that includes the facets 32 of the channel waveguides 30 can change in response to the steering of the system output signal and/or in response to changes in the distance between the object and the LIDAR system. As a result, the selection of the channel waveguides 30 that receive the LIDAR input signal can change in response to steering the system output signals to different sample regions within the field of view of the LIDAR system and/or in response to changes in the distance between the object and the LIDAR system. As one example, the selection of channel waveguides 30 that receive the LIDAR input signal moves in the direction of the arrow labeled m in FIG. 1A as the object moves closed to the LIDAR system. Accordingly, in the example of FIG. 1A, the selection of the channel waveguides 30 that receive the LIDAR input signal moves closer to the output component as the object moves further from the LIDAR system. Accordingly, the selection of the channel waveguides that receives the LIDAR input signal changes in response to changes in the location of the object relative to the LIDAR system.

The electronics 56 can also include a light source controller 63. The light source controller 63 can operate the light source 10 such that the outgoing LIDAR signal, and accordingly a resulting system output signal, has a particular frequency versus time pattern. For instance, the light source controller 63 can operate the light source such that the outgoing LIDAR signal, and accordingly a system output signal, has different chirp rates during different data periods.

The LIDAR chip can optionally include a control branch 64 for controlling the operation of the light source 10. For instance, the control branch 64 can provide a feedback loop that the light source controller 63 uses in operating the light source such that the outgoing LIDAR signal has the desired frequency versus time pattern. The control branch 64 includes a directional coupler 66 that moves a portion of the outgoing LIDAR signal from the utility waveguide 12 onto a control waveguide 68. The coupled portion of the outgoing LIDAR signal serves as a tapped signal. Although FIG. 1 illustrates a directional coupler 66 moving a portion of the outgoing LIDAR signal onto the control waveguide 68, other signal-tapping components can be used to move a portion of the outgoing LIDAR signal from the utility waveguide 12 onto the control waveguide 68. Examples of suitable signal tapping components include, but are not limited to, y-junctions, and MMIs.

The control waveguide 58 carries the tapped signal to a feedback system 70. The feedback system 70 can include one or more light sensors (not shown) that convert light signals carried by the feedback system 70 to electrical signals that are output from the feedback system 70. The light source controller 63 can receive the electrical signals output from the feedback system 70. During operation, the light source controller 63 can adjust the frequency of the outgoing LIDAR signal in response to output from the electrical signals output from the feedback system 70. An example of a suitable construction and operation of feedback system 70 and light source controller 63 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

FIG. 1B illustrates an example of a composite signal generator 130 that is suitable for use as any, all, or each of the composite signal generators 130 in the LIDAR chip of FIG. 1A. The illustrated composite signal generator 130 includes a light signal combiner 140 configured to receive light signals from one of the reference waveguides 40 and one of the channel waveguides 30. When the reference waveguide 40 receives a reference signal, the reference waveguide 40 carries the reference signal to the light signal combiner 140. When a channel waveguide 30 receives a comparative signal, the channel waveguide 30 carries the comparative signal to the light signal combiner 140. When the light signal combiner 140 receives a comparative signal and a reference signal, the light signal combiner 140 combines the comparative signal and the reference signal into a composite signal. Due to the difference in frequencies between the comparative signal and the reference signal, the composite signal is beating at a beat frequency.

The light signal combiner 140 also splits the composite signal onto a first detector waveguide 142 and a second detector waveguide 144. The first detector waveguide 142 carries a first portion of the composite signal to a first light sensor 146 that converts the first portion of the composite signal to a first electrical signal. The second detector waveguide 144 carries a second portion of the composite signal to a second light sensor 148 that converts the second portion of the composite signal to a second electrical signal. Examples of suitable light sensors include germanium photodiodes (PDs), and avalanche photodiodes (APDs).

In some instances, the light signal combiner 140 splits the composite signal such that the portion of the comparative signal included in the first portion of the composite signal is phase shifted by 180° relative to the portion of the comparative signal in the second portion of the composite signal but the portion of the reference signal in the first portion of the composite signal is not phase shifted relative to the portion of the reference signal in the second portion of the composite signal. Alternately, the light signal combiner 140 splits the composite signal such that the portion of the reference signal in the first portion of the composite signal is phase shifted by 180° relative to the portion of the reference signal in the second portion of the composite signal but the portion of the comparative signal in the first portion of the composite signal is not phase shifted relative to the portion of the comparative signal in the second portion of the composite signal.

The electronics 56 can connect the first light sensor 146 and the second light sensor 148 in each of the composite signal generators 130 as a balanced detector 149 that serves as a light detector that converts optical energy to electrical energy. For instance, the first light sensor 146 and the second light sensor 148 in each composite signal generator 130 can be connected in series between a first parallel line and a second parallel line as shown in FIG. 1C. The first sensor line 150 and the second sensor line 152 can connect the balanced detector 149 from different composite signal generators 130 in parallel and can be used to apply a bias across the balanced detectors 149.

The serial connection in each of the balanced detectors is in communication with a data line 154 that carries the output from the balanced detector as a channel signal. Although a balanced detector is disclosed as serving as a light detector, other components and/or arrangements can serve as a light detector. For instance, a single photodetector can serve as a light detector that outputs a channel signal on a data line 154.

The electronics 56 include a data processor 155 configured to generate the LIDAR data. The data processor 155 receives the channel signals from the data lines 154. As is evident from FIG. 1C, the data lines 154 and channel signals, can each be associated with one of the channel indices with a value of m=1 to M since each of them is, or carries a signal, generated from a comparative signal received on a different one of the channel waveguides 30. When one or more of the channel signals includes a contribution from a comparative signal and a reference signal, the channel signal is beating at the beat frequency of the composite signal(s) having the same channel index due to the difference in the frequencies of the contribution of the comparative signal(s) and the contribution of the reference signal(s). All or a portion of the channel waveguides 30 may not receive a comparative signal when an object is not present to reflect the system output signal or when the LIDAR input signal is directed to other channel waveguides 30. As a result, an active portion of the channel waveguides 30 receive a comparative signal and an inactive portion of the channel waveguides 30 do not receive a comparative signal or do not substantially receive a comparative signal. In some instances, a ratio of the power level of each comparative signals carried by the active portion of the channel waveguides: the power level of any comparative signals carried by the inactive portion of the channel waveguides is greater than 2:1, 10:1, or 100:1. In some instances, none of the channel waveguides is included in the active portion of the channel waveguides.

Composite signal generators 130 that receive a comparative signal from one of the channel waveguides in the active portion of the channel waveguides can be included in an active selection of the composite signal generators 130. Composite signal generators 130 that do not receive a comparative signal from one of the channel waveguides in the active portion of the channel waveguides can be included in an inactive selection of the composite signal generators 130. Composite signal generators 130 continue receiving one of the reference signals when the composite signal generator does not receive one of the comparative signals. As a result, an inactive portion of the channel signals have a contribution from a reference signal but not from a comparative signal while an active portion of the channel signals have a contribution from a reference signal and from a comparative signal. Accordingly, the active selection of the channel signals is beating at the beat frequency. Additionally, the selection of the channel signals beating at the beat frequency can change in response to changes in the position of the object relative to the LIDAR system.

Since the selection of the channel waveguides 30 that carry a comparative signal changes in response to changes in the distance between the object and the LIDAR system, the selection of channel waveguides in the active portion of the channel waveguides changes in response to changes in the distance between the object and the LIDAR system. Accordingly, the selection of channel waveguides in the inactive portion of the channel waveguides changes in response to changes in the distance between the object and the LIDAR system. As a result, the selection of composite signal generators 130 in the active portion of the composite signal generators 130 changes in response to changes in the distance between the object and the LIDAR system. Accordingly, the selection of composite signal generators 130 in the inactive portion of the composite signal generators 130 changes in response to changes in the distance between the object and the LIDAR system.

The LIDAR system can include an adder that adds or combines the channel signals to form a data signal carried on a sensor output line 162. As a result, the channel signals from each of the different channels, i=m through i=M, are added together to provide the data signal. In FIG. 1C, the data lines 154 are connected by a common data line 160. The common data line 160 acts as an example of an adder that adds the channel signals to form a data signal carried on a sensor output line 162. When one or more of the channel signals includes a contribution from a comparative signal and a reference signal, the resulting data signal also includes a contribution from one or more comparative signals and one or more reference signals. In these instances, the data signal is beating at the beat frequency of the composite signal(s) due to the difference in the frequencies of the contribution of the comparative signal(s) and the contribution of the reference signal(s). When a portion of the channel signals include a contribution from a reference signal but not from a comparative signal, the contribution(s) from the different reference signals is a source of noise in the data signal.

The sensor output line 162 that carries the data signals can optionally include an amplifier 164. Suitable amplifiers 164 include, but are not limited to, transimpedance amplifiers (TIAs).

The data processor 155 includes a beat frequency identifier 166 configured to identify the beat frequency of the data signal. The beat frequency identifier 166 includes an Analog-to-Digital Converter (ADC) 168 that receives the data signal from the sensor output line 162. The Analog-to-Digital Converter (ADC) 168 converts the data signal from an analog form to a digital form and outputs a digital data signal. The digital data signal is a digital representation of the data signal.

The beat frequency identifier 166 includes a mathematical transformer 170 configured to receive the digital data signal. The mathematical transformer 170 is configured to perform the mathematical operation on the received digital data signal. Examples of suitable mathematical operations include, but are not limited to, mathematical transforms such as Fourier transforms. In one example, the mathematical transformer 170 performs a Fourier transform on the digital signal so as to convert from the time domain to the frequency domain. The mathematical transform can be a real transform such as a real Fast Fourier Transform (FFT). A real Fast Fourier Transform (FFT) can provide an output that indicates magnitude as a function of frequency.

The mathematical transformer 170 can include a peak finder (not shown) configured to identify peaks in the output of the mathematical transformer 170. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The electronics include a LIDAR data generator 172 that receives the output from the mathematical transformer 170. The LIDAR data generator 172 treats the frequency at the identified peak as the beat frequency of the beating signals that each results from all or a portion of a comparative signal beating against all or a portion of a reference signal. The LIDAR data generator 172 can use the identified beat frequencies in combination with the frequency pattern of the LIDAR output signal and/or the system output signal to generate the LIDAR data. FIG. 1D illustrates an example of a suitable frequency pattern for a LIDAR output signal and/or the system output signal. FIG. 1D has a solid line that shows an example of a suitable frequency pattern for the LIDAR output signal and the system output signal. Accordingly, the solid line also represents the frequency pattern for the reference signal.

FIG. 1D shows the frequency versus time pattern over a sequence of two cycles labeled cycleⱼ and cycleⱼ₊₁. In some instances, the frequency versus time pattern is repeated in each cycle as shown in FIG. 1D. The illustrated cycles do not include re-location periods and/or re-location periods are not located between cycles. As a result, FIG. 1D illustrates the results for a continuous scan.

Each cycle includes K data periods that are each associated with a period index k and are labeled DPₖ. In the example of FIG. 1C, each cycle includes two data periods (with k=1 and 2). In some instances, the frequency versus time pattern is the same for the data periods that correspond to each other in different cycles as is shown in FIG. 1C. Corresponding data periods are data periods with the same period index. As a result, each data period DP₁ can be considered corresponding data periods for that same channel index (i) and the associated frequency versus time patterns are the same in FIG. 1C. At the end of a cycle, the electronics return the frequency to the same frequency level at which it started the previous cycle.

During each data period, the frequency of the system output signal varies at a constant rate. The rate can be zero but at least a portion of the data periods in each cycle have the system output signal varied at a non-zero rate. The direction and/or rate of the frequency change changes at the change of data periods from the same cycle. For instance, during the data period DP₁ and the data period DP₂, the electronics operate the light source such that the frequency of the system output signal changes at a linear rate α. The direction of the frequency change during the data period DP₁ is the opposite of the direction of the frequency change during the data period DP₂.

The beat frequencies (f_{LDP}) from two or more different data periods in the same cycle can be combined to generate the LIDAR data. For instance, the beat frequency determined from DP₁ in FIG. 1C can be combined with the beat frequency determined from DP₂ in FIG. 1C to determine the LIDAR data for a sample region. As an example, the following equation applies during a data period where electronics increase the frequency of the outgoing LIDAR signal during the data period such as occurs in data period DP₁ of FIG. 1C: f_{ub}=−f_{d}+ατ where f_{ub} is the beat frequency determined from the output of the mathematical transformer 170, f_{d} represents the Doppler shift (f_{d}=2νf_{c}/c) where f_{c} represents the optical frequency (fₒ), c represents the speed of light, ν is the radial velocity between the reflecting object and the LIDAR system where the direction from the reflecting object toward the LIDAR system is assumed to be the positive direction, and c is the speed of light. The following equation applies during a data period where electronics decrease the frequency of the outgoing LIDAR signal such as occurs in data period DP₂ of FIG. 1C: f_{db}=−f_{d}−ατ where f_{db} is the beat frequency determined from the output of the mathematical transformer 170. In these two equations, fa and t are unknowns. The electronics solve these two equations for the two unknowns. The radial velocity for the sample region then be determined from the Doppler shift (ν=c*f_{d}/(2f_{c})) and/or the separation distance for that sample region can be determined from c*f_{d}/2. Since the LIDAR data can be generated for each corresponding frequency pair output by the transform, separate LIDAR data can be generated for each of the objects in a sample region. Accordingly, the electronics can determine more than one radial velocity and/or more than one radial separation distance from a single sampling of a single sample region in the field of view.

As noted above, the channel waveguides 30 carry comparative signals that include light reflected by objects at different distances from the system output signals. Accordingly, the channel waveguides 30 and associated channel indices can be associated with different object distances. Since the composite signal generators 130 and the reference waveguides 40 are also associated with channel indices, the composite signal generator 130 and the reference waveguides 40 are also associated with different object distances. For instance, as the channel indices for the composite signal generators 130 shown in FIG. 1A increases, the distance to the object decreases. As an example, signal generators 130 that receive a comparative signal from a channel waveguide with a facet 32 that is closer to the output component 14 are further from an object than composite signal generators 130 that receive a comparative signal from a channel waveguide with a facet 32 that is further from the output component 14.

All or a portion of the reference signals carried by all or a portion of the reference waveguides 40 can have different power levels. For instance, the signal distributor 46 can distribute the reference signals to the reference waveguides 40 such that the reference waveguides 40 associated with shorter object distances receive reference signals with the same or less power than reference waveguides 40 associated with longer object distances. As an example, in the example of FIG. 1A, the signal distributor 46 can distribute the reference signals to the reference waveguides 40 such that that reference waveguides 40 associated with lower channel indices receive reference signals with the same or more power than reference waveguides 40 associated with higher channel indices. As an example, applicable to the channel index labeling scheme in FIG. 1A, the power of the reference signal carried by the reference waveguides 40 can decrease as the channel index of the reference waveguides 40 increases. For instance, the power of the reference signal carried by the reference waveguides 40 associated with channel index m can be greater than or equal to the power of the reference signal carried by the reference waveguide 40 as associated with channel index m+1 for all or a portion of the channel index values from m=1 through m=M. As an example where reference signals carried by each the reference waveguides 40 have different power levels and there are M=8 reference waveguides 40, the reference waveguides 40 associated with channel indices 1 through 8 can respectively receive reference signals that carry relative power levels of 1, 1/2, 1/4, 1/8, 1/16, 1/32, 1/64, 1/128 where the value of the channel index increases for objects that are closer to the LIDAR system. The relative power levels can be selected based on the design of the LIDAR system and the range of object distances associated with the channel index. For instance, it may become desirable to improve performance for channel indices associated with closer object distances. In these instances, the signal distributor 46 can distribute the reference signals to the reference waveguides 40 such that the reference waveguides 40 associated with longer object distances receive reference signals with the same or less power than reference waveguides 40 associated with shorter object distances. As another example, it may become desirable to improve performance for channel indices associated with mid-range object distances. In these instances, the signal distributor 46 can distribute the reference signals to the reference waveguides 40 such that the reference waveguides 40 associated with mid-range distances receive reference signals with the same or more power than reference waveguides 40 associated with object distances that are shorter and longer than the mid-range distances. Accordingly, the relative power levels as a function of the channel indices can include a peak and/or a minimum.

Since the composite signal generators 130 receive the reference signals from the reference waveguides 40, the composite signal generators 130 associated with shorter object distances receive reference signals with the same or less power than composite signal generators 130 associated with longer object distances. In the example of FIG. 1A, the composite signal generators 130 associated with lower channel indices receive reference signals with the same or more power than composite signal generators 130 associated with higher channel indices. As an example applicable to the channel index labeling scheme in FIG. 1A, the power of the reference signal received by the composite signal generators 130 can decrease as the channel index associated with the composite signal generators 130 increases. As an example where reference signals received by each the composite signal generators 130 have different power levels, the composite signal generators 130 associated with channel indices m=1 through M can receive reference signals that carry relative power levels of (1/2)^{m-1} where the value of the channel index increases for objects that are closer to the LIDAR system and the relative power levels are normalized by the power level of the reference signal received by the composite signal generators 130 associated with m=1.

Reducing the power of the reference signals received by composite signal generators 130 associated with closer object distances can reduce the noise level in the data signal. As a reflecting object becomes further from the LIDAR system, the power of the system return signal and the resulting comparative signal becomes weaker. Combining the weaker comparative signal with a more powerful reference signal increases the signal-to-noise ratio of the resulting composite signal and accordingly increases the signal-to-noise ratio of the resulting channel signal. Adding channel signals with increased signal-to-noise ratios increases the signal-to-noise ratio of the resulting data signal.

The efficiency at which the different channel waveguides 30 receive the LIDAR input signal can be a function of a variety of different factor such as aperture of the channel waveguide and the rate at which the system output signal is scanned to different sample regions. The power levels of the different reference signals can be selected so as to provide the channel signals with the same or substantially the same signal-to-noise ratio for the system output signal reflecting off an object over the full range of distances for which the LIDAR system is configured to generate reliable LIDAR data. For instance, the power levels of the different reference signals can be selected so as to provide the channel signals of a known object with an average signal-to-noise ratio that provides a variance within +/−1 dB, 2 dB, or 3 dB.

FIG. 2A is a schematic of an example of a suitable signal distributor 46. The signal distributor includes multiple splitters 176 positioned along the utility waveguide. Each of the splitters 176 is configured to move a portion of the outgoing LIDAR signal from the utility waveguide 12 onto one of the reference waveguides 40. The portion of the outgoing LIDAR signal received on a reference waveguide 40 serves the reference signal guided by that reference waveguide 40. Accordingly, each of the splitters 176 is the source of the reference signal guided by guided by one of the reference waveguides 40. The splitters 176 can be configured such that the portion of the outgoing LIDAR signal moved onto the reference waveguides 40 is different for different reference waveguides 40. As an example, when a splitter 176 is a directional coupler, the power of the reference signal output from the splitter can be tuned by changing the separation between the portion of the utility waveguide 12 and the portion of the reference waveguide 40 included in the splitter 176. As a result, the splitters 176 can be configured to provide the different reference signals with the desired power levels. In some instances, the splitters 176 are inactive, solid-state, optical components. Suitable splitters 176 include, but are not limited to, wavelength independent splitters such as optical couplers, Y-junctions, and multimode interference devices (MMIs).

FIG. 2B is a schematic of another example of a suitable signal distributor 46. The signal distributor includes cascaded splitters positioned along the utility waveguide. The cascaded splitters include a first splitter 176, transition waveguides 178 and second splitters 180. The first splitter 176 is configured to move a portion of the outgoing LIDAR signal from the utility waveguide 12 onto one of the transition waveguides 178. The portion of the outgoing LIDAR signal received on one of the transition waveguides 178 serves a reference signal precursor. The transition waveguides 178 are each configured to guide one of the reference signal precursors from the first splitter 176 to a second splitter 178 or between second splitters 178. Each of the second splitters 178 is configured to move a portion of a reference signal precursor from one of the transition waveguides 178 to one of the reference waveguides 40. The portion of the reference signal precursor received on a reference waveguide 40 serves the reference signal guided by that reference waveguide 40. Accordingly, a second splitter 178 is the source of the reference signal guided by guided by one of the reference waveguides 40. The second splitters 178 can be configured such that the portion of the outgoing LIDAR signal moved onto the reference waveguides 40 is different for different reference waveguides 40. As a result, the second splitters 178 can be configured to provide the different reference signals with the desired power levels. Although FIG. 2B illustrates each of the second splitters 178 moving a portion of a reference signal precursor onto one of the reference waveguides 40, other cascade configurations are possible. For instance, the splitters can be cascaded such that a portion of the second splitters 178 split the received reference signal precursor into multiple other reference signal precursors that are each received at a reference waveguide 40. In some instances, the first splitters 176 and second splitters 178 are inactive, solid-state, optical components. Suitable first splitters 176 and second splitters 178 include, but are not limited to, wavelength independent splitters such as optical couplers, Y-junctions, and multimode interference devices (MMIs).

FIG. 2C is a schematic of another example of a suitable signal distributor 46. The signal distributor includes cascaded splitters positioned along the utility waveguide. The signal distributor includes a splitter 176 positioned along the utility waveguide. The splitter 176 is configured to move a portion of the outgoing LIDAR signal from the utility waveguide 12 onto a transition waveguide 178. The portion of the outgoing LIDAR signal received on the transition waveguide 178 serves a reference signal precursor. The transition waveguide 178 carries the reference signal precursor to a beam distributor 182 configured to distribute the reference signal precursor to the reference waveguide 40. The portion of the reference signal precursor received by each of the reference waveguides 40 serves the reference signal carried by that reference waveguide 40. The beam distributor 182 is configured to distribute the distribute the reference signal precursor to the reference waveguide 40 such that the resulting reference signals have the desired power levels. In some instances, the beam distributor 182 an inactive, solid-state, optical component and/or includes or consists of inactive, solid-state, optical components. Suitable beam distributors include, but are not limited to, wavelength independent splitters such as optical couplers, Y-junctions, and multimode interference devices (MMIs).

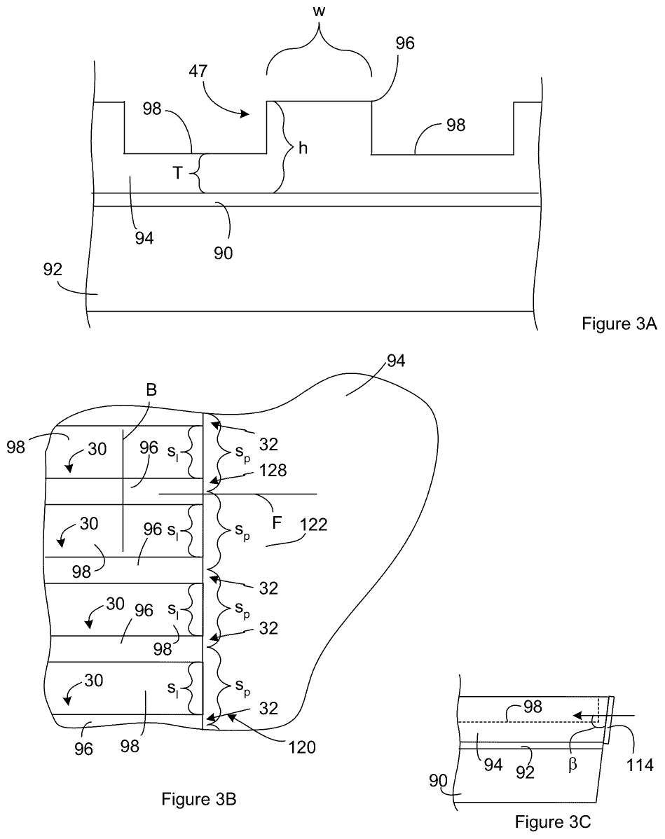

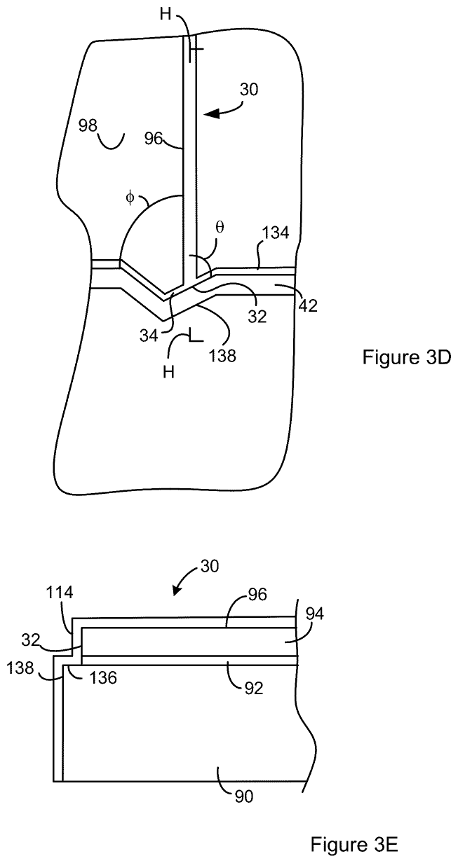

FIG. 3A through FIG. 3E illustrate an example of a suitable construction of a LIDAR chip. FIG. 3A is a cross section of a waveguide suitable for use as all or a portion of the waveguides of the LIDAR chip. Suitable platforms for the LIDAR chip include, but are not limited to, silica, indium phosphide, and silicon-on-insulator wafers. A silicon-on-insulator (SOI) wafer includes a buried layer 90 between a substrate 92 and a light-transmitting medium 94. In a silicon-on-insulator wafer, the buried layer 90 is silica while the substrate and the light-transmitting medium 94 are silicon. The substrate of an optical platform such as an SOI wafer can serve as the base for the LIDAR chip. For instance, the optical components shown in FIG. 1A and/or FIG. 1B can be positioned on or over the top and/or lateral sides of the same substrate. A ridge 96 of the light-transmitting medium 94 extends away from slab regions 98 of the light-transmitting medium 94. The light signals are constrained between the top of the ridge and the buried layer 90. As a result, the ridge 96 at least partially defines the waveguide.

The dimensions of the ridge waveguide are labeled in FIG. 3A. For instance, the ridge has a width labeled w and a height labeled h. The thickness of the slab regions is labeled T. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions.

The reference signal precursor and/or the reference signals travel through the free space region 48. The free space region 48 can be free space in the horizontal direction but guided in the vertical direction. As a result, the reference signal precursor and/or the reference signals can spread in the lateral directions and/or become more focused in the lateral directions. As a result, the free space region 48 can be a slab waveguide.

In FIG. 3B, the distance between the centers of the facets 32 is labeled sₚ. The distance between the lateral sides of adjacent channel waveguide(s) 30 at or near the facets 32 is labeled sₗ. The distances labeled sₚ and sₗ can be selected such that movement of the LIDAR input signal across the facets of the channel waveguide(s) 30 does not result in substantial loss of the comparative signals. A suitable distance between the centers of the facets 32 (sₚ) includes distances greater than 2, 3, or 5 μm and/or less than 10, 30, or 50 μm. A suitable distance between the lateral sides of adjacent channel waveguide(s) 30 at or near the facets 32 includes distances greater than 0.2, 0.4, or 0.6 μm and/or less than 0.8, 1.0, or 1.2 μm.

The distance between the centers of the facets 32 (sₚ) need not be constant and can vary. For instance, the distance between the centers of the facets 32 may be lower for the facets 32 that receive the LIDAR input signals when the object is closer to the LIDAR system than the distance between the centers of the facets 32 that receive the LIDAR input signals when the object is further from the LIDAR system. Accordingly, the distance between the centers of the facets 32 (sₚ) can increase moving in one direction across the facets. For instance, the distance between the centers of the facets 32 (sₚ) can increase moving toward the facet 32 that is closest to the utility waveguide 12 or can decrease moving toward the facet 32 that is closest to the utility waveguide 12. In one example, the distance between the centers of each pair of adjacent facets 32 (sₚ) increases moving toward the facet 32 that is closest to the utility waveguide 12.

As shown in FIG. 1A, the array waveguides 124 can separate as they move away from the facets 32. For instance, the distance between the centers of the array waveguides and the distance between the lateral sides of adjacent array waveguides can increase as the array waveguides move away facets 32 and toward the composite signal generators 130. The increase in separation can be sufficient to allow the composite signal generator 130 to be positioned adjacent to one another and/or to be staggered as shown in FIG. 1A.

FIG. 3C can represent a cross section of the portion of the LIDAR chip shown in FIG. 3B taken along the line labeled F in FIG. 3B. For instance, FIG. 3C can be a cross section taken at through a facet 32 of a channel waveguide 30 and parallel to the direction of propagation of the LIDAR input signal in the channel waveguide 30 at the facet 32. The channel waveguide 30 terminates at the facet 32. The facet 32 can be at an angle β measured in a direction that is perpendicular to a plane of the LIDAR chip and relative to the direction of propagation of the LIDAR input signal. The plane of the LIDAR chip can be an upper surface of a substrate such as the substrate 92 of FIG. 3A. The angle β can be less than 90° in order to reduce the effects of back reflection on the LIDAR output signal(s). Suitable values for the angle β include angles less than or equal to 84°, 85° or 90° and/or greater than or equal to 78°, 80°, or 82°.

The facet 32 can optionally include an anti-reflective coating 114. Suitable anti-reflective coatings 114 include, but are not limited to, single layer dielectric coatings such as silicon nitride, multi-layer dielectric coatings including silica, hafnium oxide, and aluminum oxide. Although the facet construction of FIG. 3C is disclosed in the context of a facet 32 on the channel waveguide 30, the utility waveguide 12 can terminate at a facet constructed as disclosed in the context of FIG. 3C.

FIG. 3D and FIG. 3E illustrate another possible configuration for the termination of the channel waveguide(s) 30 at a lateral side of the LIDAR chip. FIG. 3D is a topview of the device. FIG. 3E is a cross section of the device taken along the line labeled H in FIG. 3D.

A flange ridge 134 is defined in the light-transmitting medium 94 and extends outwards from the ridge 96 at the facet 32. The flange ridge 134 can be an artifact of the fabrication process and, in some instances, is not present in the optical device. When a flange ridge is present on the optical device, the facet 32 corresponds to the portion of the flange region 134 through which the light signals are transmitted into the channel waveguide 30. As a result, the facet 32 can be the portion of the flange region 134 that is optically aligned with the waveguide. Suitable light-transmitting media include, but are not limited to, silicon, polymers, silica, SiN, GaAs, InP and LiNbO₃.

The facet 32 extends upwards from a facet shelf 136. The facet shelf 136 extends outward from the facet 32 toward the lateral side 138 of the chip and is on an opposite side of the facet 32 from the channel waveguide 30. In some instances, the facet shelf 136 is parallel or substantially parallel to the top of the substrate 90.

In some instances, the facet 32 is vertical or substantially vertical relative to the top of the substrate 90. The facet 32 can also be positioned at an angle that is non-perpendicular relative to the direction of propagation of light signals through the channel waveguide 30 at the facet 32. In some instances, the facet 32 is substantially perpendicular relative to the top of the substrate 90 while being non-perpendicular relative to the direction of propagation. Suitable angles (labeled θ in FIG. 3D) for the facet 32 relative to the direction of propagation include but are not limited to, angles between 80° and 89°, and angles between 80° and 85°. An angle (labeled ¢ in FIG. 32) between the direction of propagation of light signals through the channel waveguide 30 at the facet 32 and the plane of the lateral side 138 can be less than or equal to 90°. For instance, the angle ϕ can be greater than 60° or 80° and/or less than 80° or 90°. The angle ϕ and the angle θ can be selected such that the LIDAR input signal enter the channel waveguide at an angle within a desired angular range. For instance, the angle ϕ and the angle θ can be selected such that light the LIDAR input signal entering the channel waveguide travels through the channel waveguide in a direction that is parallel or substantially parallel to the direction of propagation of light signals through the channel waveguide 30 at the facet 32.

Although not shown in FIG. 3A through FIG. 3D, a cladding can optionally be positioned on the device. The cladding can be arranged so it is located on the channel waveguides 30 without being located over the facets 32. For instance, the cladding can be in direct physical contact with the ridge 96 of the light-transmitting medium and the slab regions without being in direct physical contact with the facets 32. Suitable claddings include, but are not limited to, silica and silicon nitride.

The above LIDAR chip construction is suitable for use with various signal shapers and beam scanners. Examples of suitable beam scanners include, but are not limited to, actuated optical gratings, mirrors such as mechanically driven mirrors and Micro Electromechanical System (MEMS) mirrors, voice coil mirrors, piezoelectrically driven mirrors, and optical phased arrays. Examples of suitable signal shapers include, but are not limited to, collimating devices, lenses, and mirrors.

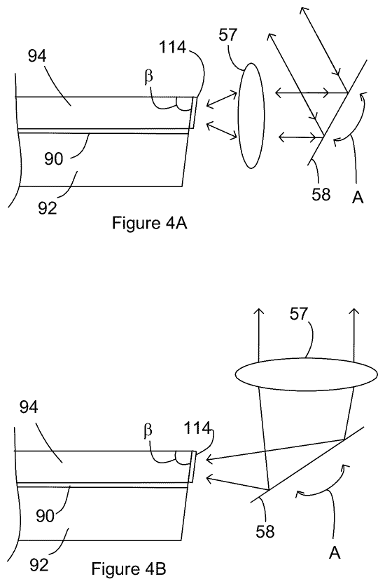

FIG. 4A is a cross section of a portion of a LIDAR system showing an example of an interface between a channel waveguide 30 constructed on a silicon-on-insulator platform, a beam scanner 58 and a first signal shaper 57. A lens serves as the first signal shaper 57 and can provide collimate or focus the shaped output signal output from the first signal shaper 57. A mirror serves as a beam scanner 58 that receives the shaped output signal and outputs the system output signal in the desired direction. As is illustrated by the arrow labeled A, the steering controller 15 in the electronics can control movement of the mirror so as to steer the collimated or focused system output signal(s) and/or scan the collimated or focused system output signal(s). The movement of the mirror can be in two dimensions or three dimensions. Suitable mirrors include, but are not limited to, mechanically driven mirrors and Micro Electromechanical System (MEMS) mirrors.

Although FIG. 4A illustrates one or more signal shapers between the LIDAR chip and one or more beam scanners, the LIDAR system can include one or more beam scanners between the LIDAR chip and one or more signal shapers. For instance, FIG. 4B illustrates the beam scanner 58 between the LIDAR chip and the first signal shaper 57.

The light sensors are illustrated as photodiodes in FIG. 1C, other light sensors are suitable. Suitable light sensors include photodiodes and other types of light sensors that can be bonded to the LIDAR chip rather than integrated with the LIDAR chip. In some instances, all or a portion of the light sensors are integrated with the LIDAR chip. For instance, the light sensors can be in-line light sensors that are each integrated with one of the array waveguides.

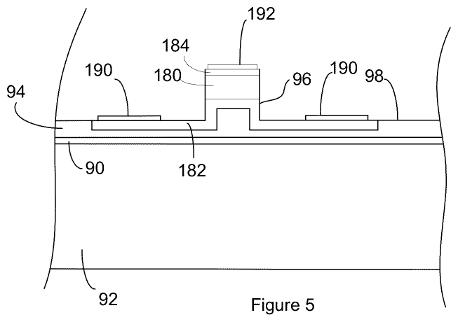

FIG. 5 provides a cross section of an in-line light sensor that is suitable for use in the above LIDAR chips. The light sensor is illustrated on a silicon-on-insulator (SOI) platform although the light sensor can be constructed on other platforms. The light sensor is integrated with a waveguide having a structure as disclosed in FIG. 3A.

The light sensor includes a light-absorbing medium 180 positioned to receive light from the waveguide. For instance, a light-absorbing medium 180 can be located on top of the ridge 96 of the light-transmitting medium 94. As a result, a portion of the light signal traveling through the waveguide enters the light-absorbing medium 180. For instance, the light-absorbing medium 180 can be configured such that the fundamental mode is coupled upward into the light-absorbing medium 180 from the light-transmitting medium 94. For instance, the index of refraction of the light-absorbing medium 180 can be higher than the index of refraction of the light-transmitting medium 94.

The light-transmitting medium 94 includes a first doped region 182 positioned in a portion of the light-transmitting medium 94 located between the light-absorbing medium 180 and the substrate 92. In some instances, the first doped region 182 contacts the light-absorbing medium 180. The light-absorbing medium 180 includes a second doped region 184. A portion of the light-absorbing medium 180 is located between the second doped 34 region and the first doped region 182.

When the first doped region 182 includes an n-type dopant, the second doped region 184 includes a p-type dopant and when the first doped region 182 includes a p-type dopant, the second doped region 184 includes an n-type dopant. Suitable dopants for N-type regions include, but are not limited to, phosphorus and/or arsenic. Suitable dopants for P-type regions include, but are not limited to, boron. A suitable concentration of carriers in the p-type region includes values greater than 1×10¹⁴/cm³, 1×10¹⁶/cm³, 1×10¹⁷/cm³, and/or less than 1×10¹⁸/cm³, 1×10¹⁹/cm³, 1×10²¹/cm³. A suitable value for the concentration of carriers in the n-type region includes values greater than 1×10¹⁴/cm³, 1×10¹⁶/cm³, 1×10¹⁷/cm³, and/or less than 1×10¹⁸/cm³, 1×10¹⁹/cm³, 1×10²¹/cm³.

The first doped region 182 is in contact with one or more first electrical conductors 190 such as a metal. The second doped region is in contact with one or more second electrical conductors 192 such as a metal. Electrical energy can be applied to the one or more first electrical conductor 190 and the one or more second electrical conductors 192 in a reverse bias so as to form an electrical field in the light-absorbing medium 180. When the electrical field is formed and the light-absorbing material absorbs a light signal, an electrical current flows through the light-absorbing material. As a result, the level of electrical current through the light-absorbing material indicates the intensity of light signals being received by the light-absorbing material.

A light-absorbing medium 180 that is suitable for detection of light signals used in LIDAR applications includes, but is not limited to, Ge.

One or more components selected from the group consisting of the mathematical transformer 170, steering controller 15, light source controller 63, data processor 155, LIDAR data generator 172, can execute the attributed functions using firmware, hardware or software or a combination thereof. In addition, or in conjunction, with the electronics 56 disclosed above, the electronics 56 can include, but are not limited to, an electronic controller that includes or consists of analog electrical circuits, digital electrical circuits, processors, microprocessors, digital signal processors (DSPs), Application Specific Integrated Circuits (ASICs), Field Programmable Gate Arrays (FPGAs), computers, microcomputers, or combinations suitable for performing the operation, monitoring and control functions described above. In some instances, the electronic controller has access to a memory that includes instructions to be executed by the electronic controller during performance of the operation, control and monitoring functions. Although the electronics are illustrated as a single component in a single location, the electronics can include multiple different components that are independent of one another and/or placed in different locations. Additionally, all or a portion of the disclosed electronics can be included on the chip including electronics that are integrated with the chip.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system configured to output a system output signal and to receive a system return signal that includes light from the system output signal that was reflected by an object located outside of the LIDAR system;
the LIDAR system including multiple composite signal generators configured to receive comparative signals such that each of the composite signal generators receives a different one of the comparative signals, each of the comparative signals including light from the system return signal,
each of the composite signal generators configured to receive multiple reference signals such that each of the composite signal generators receives a different one of the reference signals, the reference signal received by different composite signal generators having different power levels, and
each of the composite signal generators configured to combine the reference signal received by the composite signal generator with the reference signal received by the composite signal generator so as to generate a composite signal.

2. The system of claim 1, wherein the composite signal is beating at a beat frequency.

3. The system of claim 1, wherein the LIDAR system is configured such that one or more of the composite signal generators included in a selection of the composite signal generators each receives one of the comparative signals and the one or more of the composite signal generators in the selection is a function of a distance between the LIDAR system and the object.

4. The system of claim 3, wherein a first selection of the composite signal generators each receives one of the comparative signals when the object is at a first distance from the LIDAR system and a second selection of the composite signal generators each receives one of the comparative signals when the object is at a second distance from the LIDAR system, the first distance being shorter than the second distance, and
the refence signal received by each composite signal generator in the first selection of composite signal generators having a lower power level than the refence signal received by each composite signal generator in the second selection of composite signal generators.

5. The system of claim 3, wherein the composite signal generators are associated with a channel index,
the channel index associated with the composite signal generators in the selection of composite signal generators increases as the object becomes closed to the LIDAR system, and
a power level of the refences signals received by the composite signal generators decreasing as the channel index associated with the composite signal generators.

6. The system of claim 3, wherein each of the composite signal generators excluded from the selection of composite signal generators does not substantially receive one of the comparative signals.

7. The system of claim 6, wherein the selection of composite signal generators includes one composite signal generator.

8. The system of claim 1, wherein the system output signal and the reference signals include light from an outgoing LIDAR signal.

9. The system of claim 8, wherein the LIDAR system includes a utility waveguide that ends at a facet and channel waveguides that each terminate at a channel waveguide facet,
the utility waveguide carrying the outgoing LIDAR signal and the channel waveguides carrying a different one of the comparative signals,
each of the comparative signals entering a different one of the channel waveguides through the channel waveguide facet of the channel waveguide, and
a power level of the reference signals received by the composite signal generators decreasing as a distance between the facet and the channel waveguide facet through which the channel signal generator receives the comparative signal decreases.

10. The system of claim 1, wherein each of the reference signals excludes light from the system return signal.

11. The system of claim 1, wherein the LIDAR system includes channel waveguides that each terminate at a channel waveguide facet,
the channel waveguides carrying a different one of the comparative signals,
each of the comparative signals entering a different one of the channel waveguides through the channel waveguide facet of the channel waveguide, and
a distance between the centers of the channel waveguide facets being lower for the channel waveguide facet that receive the comparative signals when the object is closer to the LIDAR system than the distance between the centers of the channel waveguide facets that receive the comparative signals when the object is further from the LIDAR system.

12. The system of claim 11, wherein the system output signal and the reference signals include light from an outgoing LIDAR signal;
LIDAR system includes a utility waveguide that ends at a facet;
the distance between the centers of the channel waveguide facets increase moving toward the facet that is closest to the utility waveguide or the distance between the centers of the channel waveguide facets decrease moving toward the facet that is closest to the utility waveguide.

13. A method of operating a system, comprising:
transmitting a system output signal from a LIDAR system;
receiving at the LIDAR system a system return signal that includes light from the system output signal and that was reflected by an object located outside of the LIDAR system;
generating composite signals such that a first selection of the composite signals each includes a comparative signal combined with a reference signal,
each of the comparative signals including light from the system return signal,
a second selection of the composite signals each includes a reference signal and substantially excludes light from the system return signal,
the composite signals included in the first selection and in the second selection changing as a distance between the LIDAR system and the object changes, and
a power level of the reference signals included in the first selection of composite signals decreasing as the distance between the LIDAR system and the object decreases.
